(19) United States
(12) Patent Application Publication
(10) Pub. No.: US 2009/0163253 A1
(43) Pub. Date: Jun. 25, 2009

(54) IN-CAR COMMUNICATION APPARATUS

(75) Inventor: Robert Tsao, Taipei City (TW)

Correspondence Address: WPAT, PC;INTELLECTUAL PROPERTY ATTORNEYS, 2030 MAIN STREET, SUITE 1300, IRVINE, CA, 92614, US

(73) Assignee: GOOD WAY TECHNOLOGY CO., LTD., Taipei County (TW)

(21) Appl. No.: 11/960,183

(22) Filed: Dec. 19, 2007

(51) Int. Cl. H04M 1/00

(52) U.S. Cl. 455/569.2

(57) ABSTRACT

An in-car communication apparatus includes a connection seat being externally provided on one side with a recess, and internally including a processing unit, to which an input element, an output element, an operating element, a power plug, and a conducting section at a bottom of the recess are electrically connected; and a transmission device being removably set in the recess on the connection seat, and internally including a signal processing unit, to which a Bluetooth transceiver unit, a connector unit, a receiving unit, and a transmitting section corresponding to the conducting section are electrically connected. With these arrangements, the transmission device may be associated with the connection seat to be used as a hand-free phone in a car, and linked with a portable electronic device via the Bluetooth transceiver unit to receive and transmit speech signals and stereo musical signals.

### FIELD OF THE INVENTION

The present invention relates to an in-car communication apparatus, and more particularly to an in-car communication apparatus that may be used as a hand-free phone in a car, and linked with a portable electronic device via Bluetooth transceiving technique to receive and transmit speech signals and stereo musical signals.

### BACKGROUND OF THE INVENTION

It is very dangerous for a driver to answer an in-coming call on a cell phone while driving. In the event the driver does not use a hand-free phone, he or she has to control the steering wheel with one hand and hold the phone with the other hand. By doing this, the driver tends to be distracted from driving and fails to respond to a suddenly occurred condition, resulting in dangers or even a tragedy during driving. Therefore, according to relevant laws and regulations, a driver is prohibited from holding a cell phone while driving. When necessary, the driver can answer an in-coming call only with a hand-free phone.

Generally, hand-free phones may be divided into two types, namely, wired headphones and wireless Bluetooth earphones. The wired headphones are connected to the cell phone using a wire. Due to the limited length of the wire, the cell phone connected to the wired headphones could not be conveniently placed in the car at any desired position. Moreover, to avoid the wire between the headphones and the cell phone from interfering with the steering wheel, most drivers would take off the headphones when there is not any in-coming call to answer. As a result, when the cell phone rings, the driver has to fetch the headphones in a hurry and becomes distracted from driving carefully.

While Bluetooth earphones do not have the wire problem, they would still form a hindrance to the driver' hearing and dangerously lower the driver's ability in responding to external environment. Moreover, since Bluetooth earphones are expensive, it would be impractical to use the Bluetooth earphones only as means for communicating with a cell phone.

### SUMMARY OF THE INVENTION

A primary object of the present invention is to provide an in-car communication apparatus that may be used as a hand-free phone in a car, and linked with a portable electronic device via a Bluetooth transceiver unit to receive and transmit speech signals and stereo musical signals.

To achieve the above and other objects, the in-car communication apparatus according to the present invention includes a connection seat being externally provided on one side with a recess, and internally including a processing unit, to which an input element, an output element, an operating element, a power plug, and a conducting section at a bottom of the recess are electrically connected; and a transmission device being removably set in the recess on the connection seat, and internally including a signal processing unit, to which a Bluetooth transceiver unit, a connector unit, a receiving unit, and a transmitting section corresponding to the conducting section are electrically connected.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is an exploded view of an in-car communication apparatus according to the present invention;

FIG. 2 is a conceptual view showing one manner of using the in-car communication apparatus of the present invention; and

FIGS. 3 and 4 show another manner of using the in-car communication apparatus of the present invention.

### DETAILED DESCRIPTION OF THE PREFERRED EMBODIMENTS

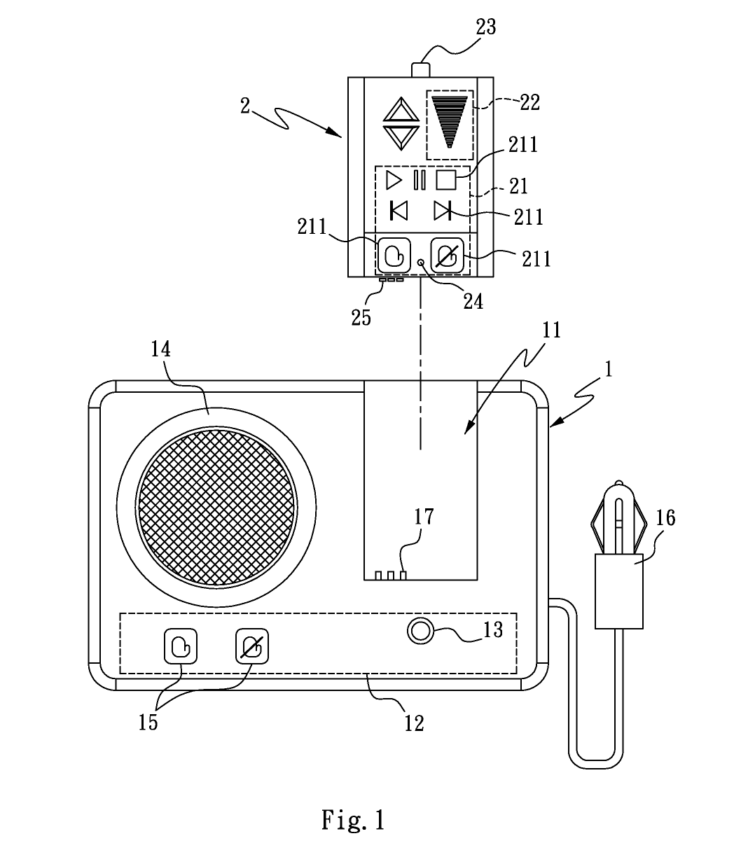

Please refer to FIG. 1 that is an exploded view of an in-car communication apparatus according to the present invention. As shown, the in-car communication apparatus of the present invention includes a connection seat 1 and a transmission device 2. The transmission device 2 may be associated with the connection seat 1 for use in a car as a hand-free phone, and linked with a portable electronic device for receiving and transmitting audio signals.

The connection seat 1 is externally provided on one side with a recess 11, and internally includes a processing unit 12, to which an input element 13, an output element 14, an operating element 15, a power plug 16, and a conducting section 17 at a bottom of the recess 11 are electrically connected. Wherein, the input element 13 may be a microphone, the output element 14 may be a loudspeaker, the operating element 15 may include a plurality of keys, and the power plug 16 may be a plug matching with a cigarette lighter in the car.

The transmission device 2 is removably set in the recess 11 on the connection seat 1, and internally includes a signal processing unit 21, to which a Bluetooth transceiver unit 22, a connector unit 23, a receiving unit 24, and a transmitting section 25 corresponding to the conducting section 17 are electrically connected. Wherein, the signal processing unit 21 includes a plurality of control keys 211, the receiving unit 24 may be a microphone, and the connector unit 23 may be an earphone jack.

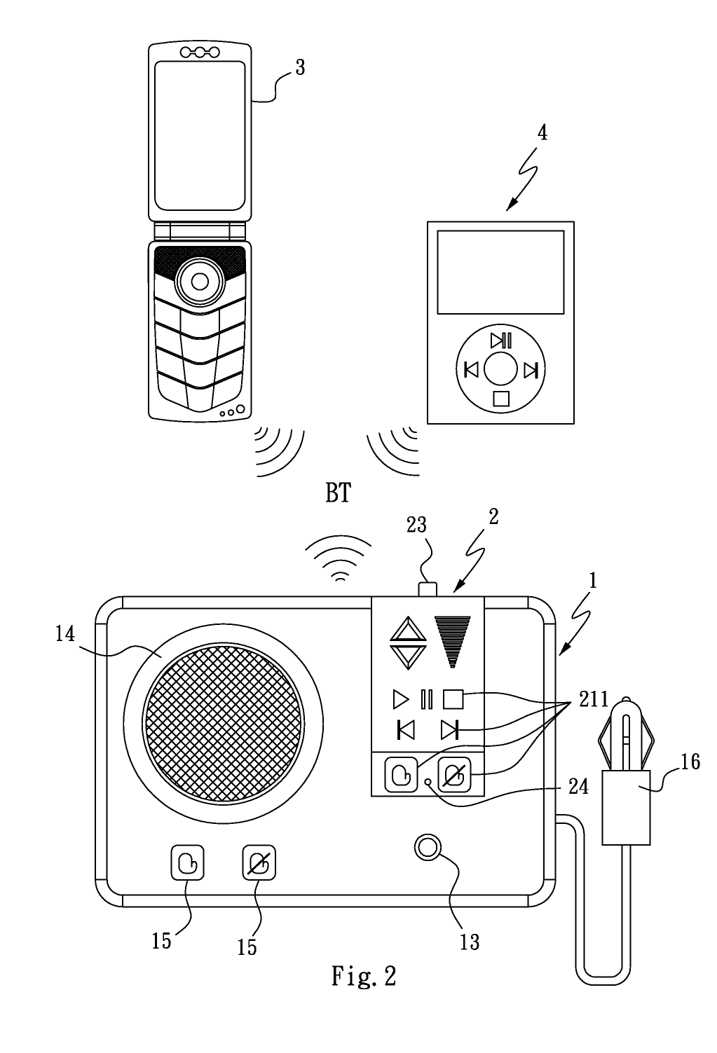

Please refer to FIG. 2 along with FIG. 1. To use the in-car communication apparatus of the present invention in a car, first plug the power plug 16 of the connection seat 1 into a cigarette lighter in the car to obtain power supply from the car, and set the transmission device 2 in the recess 11 on the connection seat 1, so that the transmitting section 25 of the transmission device 2 is in electrical contact with the conducting section 17 in the recess 11. Then, mount the connection seat 1 in the car using suitable fastening elements (not shown).

The transmission device 2 may be linked with a portable electronic device, such as a cell phone 3 or a music player 4, via the Bluetooth transceiver unit 22. When it is desired to use the cell phone 3 as a hand-free phone, the user may use the operating element 15 to select the movement of answering phone or hanging up phone. When the movement of answering phone is selected, speech signals from the cell phone 3 is received via the Bluetooth transceiver unit 22 and transmitted to the processing unit 12 via the transmitting section 25 and the conducting section 17, so as to be output at the output element 14 on the connection seat 1; and the user's answering speech is input at the input element 13 and transmitted to the processing unit 12, and then transmitted via the conducting section 17, the transmitting section 25, and the Bluetooth transceiver unit 22 to the cell phone 3. It is not necessary for the user to pick up and hold the cell phone 3 at all. Meanwhile, the connection seat 1 may cooperate with the transmission device 2, so that musical signals from the music player 4 is received via the Bluetooth transceiver unit 22 and then transmitted via the transmitting section 25 and the conducting section 17 to the processing unit 12, and finally output at the output element 14 on the connection seat 1, allowing the music player 4 to play music via the in-car communication apparatus of the present invention.

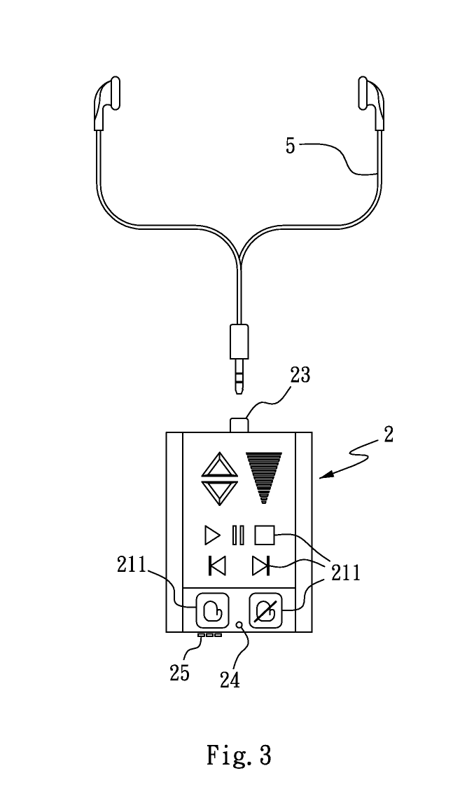

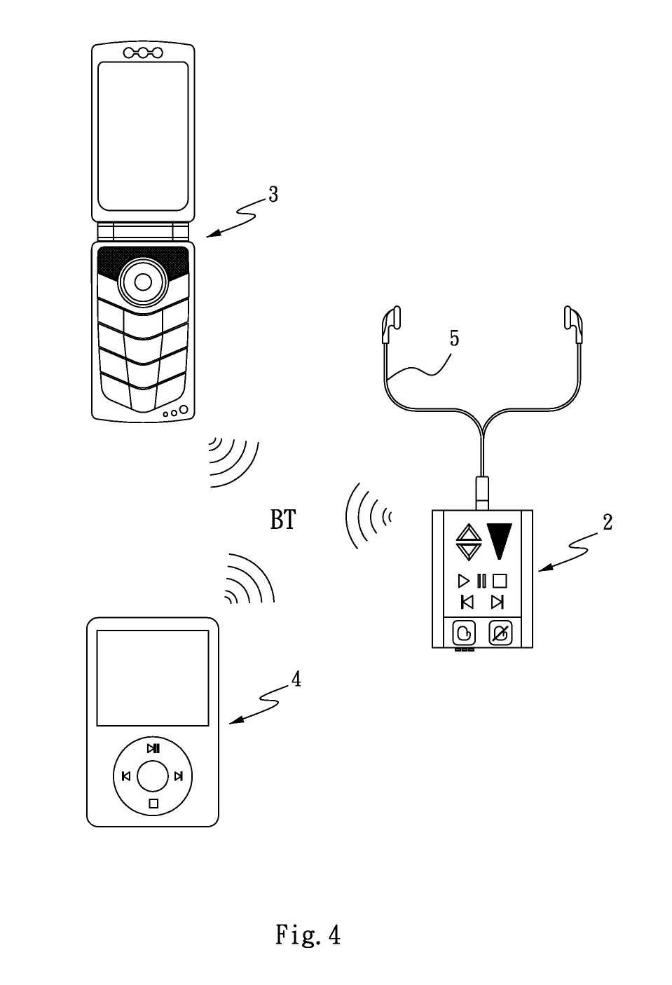

FIGS. 3 and 4 show the manner of using the transmission device 2 alone. As shown, to use the transmission device 2 alone, first connect earphones 5 to the connector unit 23, and link the Bluetooth transceiver unit 22 with a cell phone 3 and a music player 4. When it is desired to use the cell phone 3 as a hand-free phone, the user may use the control keys 211 on the transmission device 2 to select the movement of answering phone or hanging up phone. When the movement of answering phone is selected, speech signals from the cell phone 3 is received via the Bluetooth transceiver unit 22 and output via the ear phones 5; and the user's answering speech is input at the receiving unit 24 and transmitted to the cell phone 3 via the Bluetooth transceiver unit 22. Again, it is not necessary for the user to pick up and hold the cell phone 3 at all. Meanwhile, musical signals from the music player 4 may be received via the Bluetooth transceiver unit 22 and output via the earphones 5, allowing the music player 4 to play music via the transmission device 2.

With the above arrangements, the transmission device 2 included in the in-car communication apparatus of the present invention may be connected to the connection seat 1 for use as a hand-free phone in a car, and linked with a portable electronic device via the Bluetooth transceiver 22 for receiving and transmitting speech signals and stereo musical sound signals. Therefore, the present invention effectively overcomes the drawbacks in the conventional in-car communication apparatus to meet users' need, and is more practical for use.

What is claimed is:

1. An in-car communication apparatus, comprising:
a connection seat being externally provided on one side with a recess, and internally including a processing unit, to which an input element, an output element, an operating element, a power plug, and a conducting section at a bottom of the recess are electrically connected; and
a transmission device being removably set in the recess on the connection seat, and internally including a signal processing unit, to which a Bluetooth transceiver unit, a connector unit, a receiving unit, and a transmitting section corresponding to the conducting section are electrically connected.

2. The in-car communication apparatus as claimed in claim 1, wherein the input element is a microphone.

3. The in-car communication apparatus as claimed in claim 1, wherein the output element is a loudspeaker.

4. The in-car communication apparatus as claimed in claim 1, wherein the operating element includes a plurality of keys.

5. The in-car communication apparatus as claimed in claim 1, wherein the power plug matches with a cigarette lighter in a car.

6. The in-car communication apparatus as claimed in claim 1, wherein the signal processing unit includes a plurality of control keys.

7. The in-car communication apparatus as claimed in claim 1, wherein the receiving unit is a microphone.

8. The in-car communication apparatus as claimed in claim 1, wherein the connector unit is an earphone jack.
